(19) United States
(12) Patent Application Publication
(10) Pub. No.: US 2011/0240340 A1
(43) Pub. Date: Oct. 6, 2011

(54) ELECTRICALLY CONDUCTIVE FLOC AND ELECTRICALLY CONDUCTIVE BRUSH

(75) Inventors: Hidetoshi Takanaga, Aichi (JP); Yoshitaka Matsumura, Aichi (JP); Hanji Ishikawa, Fukui (JP)

(73) Assignee: Toray Industries ,Inc., Chuo-,Tokyo (JP)

(21) Appl. No.: 13/131,397

(22) PCT Filed: Dec. 1, 2009
(86) PCT No.: PCT/JP2009/070140

§ 371 Date: May 26, 2011

(30) Foreign Application Priority Data
Dec. 2, 2008 (JP) 2008-307125

(51) Int. Cl. H01B 5/00; H01R 43/00

(52) U.S. Cl. 174/133 R; 29/825

(57) ABSTRACT

An electrically conductive floc is provided that does not need shearing in producing brushes with a smooth surface. The electrically conductive floc includes electrically conductive chemical fibers wherein said fibers have a diameter of 10 to 100 μm, a fiber length of 0.1 to 5 mm, and a fiber length variation of 5% or less.

### FIELD OF THE INVENTION

The invention relates to an electrically conductive floc and an electrically conductive brush to be used in electrophotographic machines such as xerographic copier, facsimile, and printer. Specifically, it relates to an electrically conductive floc to be used in electrically conductive brushes manufactured by electrostatic flocking, and an electrically conductive brush produced thereof.

### BACKGROUND OF THE INVENTION

Many electrically conductive rollers are used in different constituent units of an electrophotographic copier, such as the electrification unit that plays an important role in electrostatic latent image formation, cleaning unit to remove toner and electric charge from the photoconductor, and supply unit to electrically charge toner. In recent years, however, higher-resolution color machines account for a larger part, and they use finer toner particles. When used in machines equipped with electrically conductive rollers of silicone or polyurethane, such finer toner tends to get in the bubbles on the roller surface to make the roller surface stiff, or fuse to cause the toner filming problem that leads to an increase in the resistance of the roller surface. For this, Patent documents 1 and 2 have proposed electrically conductive brushes in which the roller surfaces are electrostatically flocked with electrically conductive fiber. A method to process fibers to be used for electrostatic flocking has also been proposed in a non-patent document 1. If a floc with a fiber length of 0.5 mm or more is to be produced, when yarns are cut into short fibers, the tow will be broken under the pressure of the blade, and the yarns tend to shift in position, leading to a variation in the fiber length. In the case of electrically conductive brushes used in electrophotographic copiers, in particular, the surface should be as smooth as possible to allow uniform electric charge to be given to the photoconductor and toner. In the case of brushes comprising a floc with a fiber length of 0.5 mm or more, therefore, their manufacturing process used conventionally contains a shearing step to cut fibers in the brush surface to a uniform length. The shearing step to cut the fibers of the brush surface, however, can cause problems, as it leads to a loss of fibers and the shearing step results in a decrease in production efficiency.

[Prior Art Documents]

[Patent document 1] Japanese Unexamined Patent Publication (Kokai) No. HEI-10-123821

[Patent document 2] Japanese Unexamined Patent Publication (Kokai) No. 2004-70006

[Non-patent document 1] Journal of the Institute of Electrostatics Japan, Vol. 16, No. 5, p. 389-395, 1992

### SUMMARY OF THE INVENTION

The invention aims to provide an electrically conductive floc that does not need shearing in producing brushes with a smooth surface.

The above-mentioned aim of the invention can be achieved by electrically conductive floc that has a constitution as described in the following embodiment (1) of the invention.

(1) An electrically conductive floc comprising electrically conductive chemical fibers wherein said chemical fibers have a diameter of 10 to 100 μm, a fiber length of 0.5 to 5 mm, and a fiber length variation of 5% or less.

(2) An electrically conductive floc as specified in paragraph (1) wherein said chemical fibers contain electrically conductive fine particles.

(3) An electrically conductive floc as specified in paragraph (2) wherein said electrically conductive fine particles are of carbon black and account for 5 to 40 mass % of the chemical fibers.

(4) An electrically conductive floc as specified in any of paragraphs (1) to (3) wherein said chemical fibers are of thermoplastic resin.

(5) An electrically conductive floc as specified in paragraph (4) wherein said thermoplastic resin is polyamide.

(6) An electrically conductive brush produced by electrostatic flocking with an electrically conductive floc as specified in any of paragraphs (1) to (5).

(7) A production method for an electrically conductive floc as specified in any of paragraphs (1) to (5) wherein a tow of electrically conductive chemical fibers with a fineness of 500,000 to 5,000,000 decitex are fixed to prevent its movement in the perpendicular direction to the fiber axis, followed by cutting the tow to produce short fibers and subjecting them to electrostatic treatment.

According to embodiments of the invention, an electrically conductive floc free of a significant fiber length variation can be obtained as described below.

### DETAILED DESCRIPTION OF THE INVENTION

The electrically conductive floc of embodiments of the invention is described in more detail below. The term “floc” as used for the invention refers to a material used for electrostatic flocking that is in the form of electrostatic-treated fibers. The chemical fibers to be used for the invention include so-called reclaimed fibers, semisynthetic fibers, and synthetic fibers. The reclaimed fibers include rayon and cupra, the semisynthetic fibers including acetate and triacetate, and the synthetic fibers including acrylic, polyamide, polyester, nylon, and vinylon. Of the chemical fibers, synthetic fibers are particularly preferable because it is easy to control their diameter when producing them and it is also easy to disperse electrically conductive fine particles. Furthermore, thermoplastic resins such as polyamide and polyester are preferable because they are easy to produce. Polyamide is a polymer consisting of hydrocarbon groups connected to the backbone chain through amide bonds, and the polyamide material to be used here should consist mainly of polycaproamide or polyhexamethylene adipamide. The term “mainly” refers to a state where polycaproamide or polyhexamethylene adipamide account for 80 mol % or more, more preferably 90 mol % or more, in terms of the e-caprolactam unit or the hexamethylene diammonium adipate unit that constitute the polycaproamide or polyhexamethylene, respectively. In particular, it is preferable that the polyamide material comprises polycaproamide and polyhexamethylene adipamide.

For purposes of the invention, a material that is “electrically conductive” has the ability to conduct an electric current, and the electrical conductivity is measured in terms of specific resistance. It is preferable that said electrically conductive floc to be used here has a specific resistance of 10⁰ to 10¹⁰ Ωcm because the electrically conductive brush produced from it should be able to give or remove electric charge.

Said chemical fibers to be used for the invention should preferably be electrically conductive. If the chemical fibers are not electrically conductive, the brush produced from it will not be able to electrically charge a photoconductor or toner. The methods available to make chemical fibers electrically conductive include dispersing electrically conductive fine particles in the fibers, and coating the fiber surface with an electrically conductive polymer such as polypyrrole. For large-type electrophotographic recorders, in particular, the method of dispersing electrically conductive fine particles in the fibers is preferable because the fiber surface preferably maintains a constant resistance as the number of printed sheets increases.
There are no specific limitations on the electrically conductive fine particles to be used, and they include electrically conductive carbon black materials, electrically conductive metal compounds, and inorganic compounds plated or coated with electrically conductive metal, of which carbon black materials are particularly preferable because they are small in particle diameter and highly dispersible in chemical fibers. There are no specific limitations on the electrically conductive carbon black materials to be used here if they are electrically conductive, and they include acetylene black, channel black, and furnace black, of which furnace black is preferable because its powder has a small and relatively uniform particle size. If the powder has a large particle size, the filtration pressure rise will be depressed during spinning, or the thread will break during spinning, and therefore, the diameter is preferably 2 μm or less to ensure improved fiber strength.

If electrically conductive carbon black is used as said electrically conductive fine particles, it is preferable that the electrically conductive carbon black accounts for 5 to 40 mass % of the entire electrically conductive floc. If the electrically conductive carbon black accounts for less than 5 mass %, the chemical fibers will be too high in specific resistance, and an electrically conductive brush comprising it will not be able to electrically charge a photoconductor or toner, possibly failing to form an image. If the electrically conductive carbon black accounts for more than 40 mass %, the chemical fibers will be too low in specific resistance, and an electrically conductive brush comprising it will not be able to electrically charge a photoconductor or toner, possibly failing to form an image. It is more preferable that its content is 15 to 35 mass %.

Said electrically conductive floc preferably has a fiber diameter of 10 to 100 μm. If the fiber diameter is less than 10 μm, bristles of a brush comprising the fibers will be easily bent down, failing to apply a required contact pressure to the photoconductor or toner, electrically charge the photoconductor or toner, and form an image. If the fiber diameter exceeds 100 μm, the flocking density will decrease and the charge density also decreases, leading to deterioration in image quality.

Said electrically conductive floc preferably has a fiber length of 0.5 to 5 mm. If the fiber length is less than 0.5 mm, toner will get in the surface of a brush comprising the floc to make the brush surface stiff, or fusion of toner, i.e. toner filming, will take place to increase the resistance of the brush surface, leading to deterioration in printing durability. If the fiber length exceeds 5 mm, floc entanglement will take place during the electrostatic flocking process, and individual fibers in the floc do not disperse adequately, leading to inadequate flocking.

Said electrically conductive floc preferably has a fiber length variation of 5% or less. If the fiber length variation exceeds 5%, the surface of a brush comprising the fibers will suffer irregularities, and electric charge will not be given uniformly to a photoconductor or toner, leading to deterioration in image quality. A smaller fiber length variation is more preferable, but industrially, the lower limit is 1% or so.

To produce said electrically conductive floc, a fiber tow (bundle of continuous filaments) is heat-treated in a hot water at 80 to 98° C. for 30 to 60 minutes. This serves to remove oil agents from the fibers, and shrink the fibers in the case of chemical fibers containing electrically conductive fine particles, leading to a decreased variation in specific resistance. It also serves to provide electrically conductive floc or an electrically conductive brush that will suffer little changes in resistance over time. An appropriate cutting machine such as guillotine cutter is used to cut such a tow treated in hot water. Features of the cut surface depends on the structure of the cutting machine used and the relation between the blade and the fibers, but it is preferable the fibers and the blade contact perpendicularly with each other and the fibers are cut perpendicularly to the fiber axis. At this time, if a tow in a common state is cut, the tow will be broken under the pressure of the blade, and the position of the fiber will shift during the cutting step, leading to a significant variation in fiber length. To prevent movements of the fibers, the tow may be wrapped with paper or film, and cut in a wrapped state, or a resin container may be stuffed with the tow and cut together, so that the tow will not be broken when cut, preventing movement of the fibers and maintaining a decreased fiber length variation. After the cutting, the paper, film, resin container, etc. should be removed by sieving. If the number of fibers to form a tow is small, the tow will not move significantly during the cutting step and the fiber length variation will be reduced, but the work load will increase. Thus it is preferable that the fineness of the tow is adjusted to 500,000 to 5,000,000 decitex. To maintain jumping capability of the floc, it is preferable that the short fibers in the electrically conductive floc are free of twisting or curving. If paper is used to wrap the tow, it is preferable for the paper to be tough and flexible to allow easy bundling of fibers into a tow. The use of kraft paper, which is used to produce products such as envelope, is preferable, and it should preferably have a tensile strength of 0.3 N or more.

Said electrically conductive floc is produced by coating a substrate with an adhesive, and flocking it using static electricity. In the electrostatic flocking process, an electric field under a high voltage electrically influences a small object existing in the field. Under this electric influence, the small object is electrified, and pulled from an electrode toward the other. Specifically, if a high-voltage direct current is applied to metal pieces, an electric field (E) is formed between them. The strength of the electric field has a relation with the voltage (V) and the distance (d) as follows: E=V/d. The electric charge (q) on a small object existing in this electric field is pulled by a force (F) as expressed by the following equation: F=Eq. The small object is a floc here. For electrostatic flocking, the positive electrode and the negative electrode are called the high-voltage electrode and the grounding (earth) electrode, respectively, and a high-voltage generator is provided to apply a predetermined voltage (V) to the electric field. In the electrostatic flocking equipment, a substrate is placed between the electrodes perpendicularly to the electrode surfaces, and floc fibers jumping from one electrode toward the other stick perpendicularly into the substrate which is coated with an adhesive. Thus, the jumping capability of the floc depends on the electric charge (q).

Said electrically conductive floc is produced by processing said fibers with an electrostatic treatment agent. It is preferable that the quantity of the electrostatic treatment agent given to the fibers accounts for 1 to 7 mass % relative to the ash content of the electrically conductive floc. Said ash content is calculated by the ash measurement method for the chemical fiber staple test specified in JIS (JIS L 1015 (1999)).

Said electrostatic treatment agent is a liquid to charge the floc for electrostatic flocking, and more specifically, it acts electrically on the floc fibers to allow them to jump appropriately in an electric field. Electrostatic treatment agents useful to prepare an electrically conductive floc include, for example, tannic acid; inorganic salts such as sodium chloride, barium chloride, magnesium chloride, magnesium sulfate, sodium nitrate, and zirconium carbonate; surface active agents such as anion active agents and nonionic active agents; silicon compounds such as colloidal silica; and others such as alumina sol and polypyrrole.

There are no specific limitations on the electrostatic treatment method for said electrically conductive floc for the invention, and for instance, fiber material may be cut to provide short fibers and electrostatic-treated by immersing them in an aqueous solution of an electrostatic treatment agent diluted with a binder. The aqueous solution of the electrostatic treatment agent preferably has a concentration of 30 to 100 g/liter in view of the viscosity of the aqueous solution and the efficiency of electrostatic treatment.

Said electrostatic treatment agent preferably contains a silicon compound, which is preferably colloidal silica. Colloidal silica, in particular, is high in dispersibility in water, allowing uniform electrostatic treatment of short fibers to be performed easily. Colloidal silica is preferable also because it bonds specifically to the hydroxyl group in polyamide, and therefore, resists friction.

Said electrostatic treatment agent may be an aqueous solution of a silicon compound alone, but more preferably an aqueous solution of a mixture of colloidal silica and alumina sol. This is because colloidal silica and alumina sol mix well, and serve to produce an electrically conductive floc that can be electrically charged to a high degree under a high voltage and that can be separated easily. Furthermore, when chemical fibers containing electrically conductive fine particles with a specific resistance of less than 10⁶ Ωcm are used, their jumping capability will be low because even under a high voltage the electricity passes away, failing to accumulate electric charge, but the addition of an aqueous solution of a mixture of colloidal silica and alumina sol works to increase the resistance of the floc surface up to 10⁶ to 10⁸ Ωcm and accordingly improve the jumping capability. To produce a mixture of colloidal silica and alumina sol, it is preferable that an aqueous solution of colloidal silica and an aqueous solution of alumina sol are prepared separately and mixed subsequently because this can depress the increase in viscosity and achieve uniform dispersion. The mixing ratio between colloidal silica and alumina sol is preferably 6:1 to 3:1 to achieve uniform dispersion and allow the floc surface to have a desired resistance value.

After undergoing electrostatic treatment, the electrically conductive floc is dehydrated in a rotary dehydration machine, dried at 100 to 130° C. for 30 to 60 minutes, and sieved to provide fibers with a constant length.

The electrically conductive brush is an electrically conductive brush that is produced by subjecting said electrically conductive floc to electrostatic flocking and designed to be used for static elimination, electrical charging, and dust removal.

As the electrically conductive brush is produced by subjecting an electrically conductive floc to electrostatic flocking, a uniform resistance can be achieved around the circumference of the electrically conductive brush, allowing it to show particularly high performance when used in an electrophotographic recording type xerographic copier. Such brushes incorporated in an electrophotographic recording type xerographic copier work as an electricity-applying brush that comes in contact with the photoconductor to electrostatically charge it instead of noncontact corona discharge, a cleaning brush that cleans the photoconductor to remove the remaining electric charge and toner, a toner supply brush that is incorporated in the toner cartridge to electrostatically charge the toner to promote the adsorption of the toner on the photoconductor, and a transfer brush that electrostatically charges printing paper to allow the toner on the photoconductor to be transferred to the printing paper. In any case, a core in the form of a cylindrical metal rod is coated with an adhesive, and electricity with a voltage of 10 kV to 50 kV is applied to perform electrostatic flocking with an electrically conductive floc, followed by drying and dehairing to produce a brush. There are no specific limitations on the metal rod used as the core if it is electrically conductive, but it is preferably stainless steel. There are no specific limitations on the adhesive, but an adhesive composed mainly of, for instance, acrylic resin, polyvinyl acetate, polyurethane, synthetic rubber, or natural rubber can work satisfactorily, and an adhesive composed mainly of acrylic resin is preferable. It is also preferable that the adhesive used contains an electrically conductive substance such as electrically conductive carbon to develop electrical conductivity.

### EXAMPLES

The invention is described in more detail below with reference to Examples. The following methods were used to take measurements

A. Fiber Diameter

A total of 10 fibers were selected randomly from an electrically conductive floc, and observed by SEM at a magnification of 800× to measure their fiber diameters, followed by calculating the average.

B. Fiber Length

A total of 50 fibers were selected randomly from an electrically conductive floc, and observed with a high-magnification projector at a magnification of 50× to measure their fiber diameters, followed by calculating the average.

C. Fiber Length Variation

A total of 50 fibers were selected randomly from an electrically conductive floc, and observed with a high-magnification projector at a magnification of 50× to measure their fiber diameters, followed by calculation by the following formula (1):

CV=S/R×100 (1)

CV: variation (%)

S: standard deviation (mm) of the fiber length of the electrically conductive floc

R: average (mm) of the fiber length of the electrically conductive floc

D. jumping capability

In a SPG flock motion tester supplied from Erich Schenk (so-called “up method”: jumping distance 15 cm), electricity of a voltage of 20 KV was applied to an electrically conductive floc specimen, and the time required for the entire 5 g specimen to have jumped away was measured. A shorter required time for jumping indicates a higher jumping capability, and evaluation was performed according to the following criteria.

⊙: 10 to less than 20 seconds

◯: 20 to less than 30 seconds

Δ: 30 to less than 40 seconds

x: 40 seconds or more

x Specific Resistance of Fiber

Using a superinsulation resistance meter (Teraohmmeter R-503, supplied by Kawaguchi Electric Works Co., Ltd.), a voltage of 100 V is applied across a polyamide fiber specimen with a length of 10 cm, and the electric resistance (Ω/cm) was measured under the conditions of a temperature of 20° C. and a humidity of 30% RH, followed by calculation by the following formula (1)

i RS=R×D/(10×L×SG)×10⁻⁵ (2)

RS: specific resistance (Ωcm)

R: electric resistance (Ω)

D: mass of yarn per 10,000 m

L: specimen length (cm)

SG: density of yarn (g/cm³)

### F. Initial Printed Image

A test chart provided by the Imaging Society of Japan was used to print 10 copies, and their features (blur, streak) were compared with the original and scored as follows:

10 points: no difference (free of blur or streaks)

5 points: slight difference found (blur or streaks found, though not conspicuous)

1 point: significant difference found (significant blur or streaks found)

The total of the points given by the 10 testers was calculated, and evaluation was made according to the following criteria.

⊙: 75 points or more

◯: 50 points or more, less than 75 points

Δ: 25 points or more, less than 50 points

x: less than 25 points .

H. Printing Durability

A test chart provided by the Imaging Society of Japan was used to print 20,000 copies, and their features (blur, streak) were compared with the original and scored as follows:

10 points: no difference (free of blur or streaks)

5 points: slight difference found (blur or streaks found, though not conspicuous)

1 point: significant difference found (significant blur or streaks found)

The total of the points given by the 10 testers was calculated, and evaluation was made according to the following criteria.
⊙: 75 points or more

◯: 50 points or more, less than 75 points

Δ: 25 points or more, less than 50 points

x: less than 25 points .

### Example 1

In a 98% concentrated sulfuric acid solution with 1 mass % resin, electrically conductive furnace black with an average particle diameter of 0.035 μm was added to a nylon 6 material with a relative viscosity of 2.73 as measured at 25° C. with an Ostwald viscometer, up to a content of 25 mass %, and kneaded to produce pellets of electrically conductive nylon 6. The resulting pellets were melted at a melting temperature of 280° C., and discharged through a round orifice with a pore size of 0.3 mm, followed by cooling. A spinning lubricant diluted with water was supplied for deposition on the yarn so that it accounted for 0.7%, and the unstretched yarn was wound up at a take-up speed of 800 m/min. Subsequently, the unstretched yarn was aged for 48 hours in an environment with a temperature of 25° C. and an absolute humidity of 16.6 g/m³, stretched in a stretching machine at a supply roller speed of 300 m/min, heat plate temperature of 170° C., and stretching roller speed of 500 m/min, and twisted by a down twister at a rate of 15 t/m to produce a 170 decitex, 20 filament long-fiber yarn of electrically conductive nylon 6. The resulting long-fiber yarn of nylon 6 had a specific resistance of 10⁶ Ωcm.

The resulting long-fiber yarn of electrically conductive nylon 6 was wound 10,000 times on a hank winder with a circumference of 3 m to produce a tow of about 1,700,000 decitex, which was heat-treated in hot water at 98° C. for 30 minutes, wrapped in kraft paper with a tensile strength of 0.5 N, cut with a guillotine cutter into short fibers with a fiber length of 1.5 mm to provide short fibers of electrically conductive nylon 6.

The resulting short fibers of electrically conductive nylon 6 were ctrostatic-treated by immersing them for 30 minutes in a 40° C. aqueous solution of an electrostatic treatment agent prepared by mixing a 50 gaiter aqueous solution of colloidal silica (Snowtex-O, supplied by Nissan Chemical Industries, Ltd.) and a 50 g/liter aqueous solution of alumina sol (Alumina Sol −100, supplied by Nissan Chemical Industries, Ltd.) at a mixing ratio of 6:1. Then, the fibers were dried at 120° C. for 5 minutes, and sieved through a 40-mesh metal gauze to provide an electrically conductive floc with a fiber diameter of 30 μm. The resulting electrically conductive floc had a fiber length variation of 2.5%. The jumping capability was 15 seconds and rated as ⊙.

Then, a core, which was in the form of a cylindrical stainless steel rod, was coated with an acrylic resin adhesive containing electrically conductive carbon, and a voltage of 20,000 V was applied to carried out electrostatic flocking by the down method, followed by drying, dehairing, and shearing to produce a brush. The resulting electrically conductive brush had a resistance of 10⁸ Ω. The resulting brush was incorporated in the toner supply brush device of an electrophotographic recording type xerographic copier, and copying of a test chart was repeated 20,000 times, resulting in an initial image rating of ⊙ and a printing durability rating of ⊙.

### Example 2

Except that the yarn of electrically conductive nylon 6 was wound 3,000 times on a hank winder with a circumference of 3 m to prepare a tow of about 510,000 decitex, the same procedure as in Example 1 was carried out to produce polyamide long fibers, an electrically conductive floc, and a brush. Results are shown in Table 1.

### Example 3

Except that the melt was discharged through a round orifice with a pore size of 0.2 mm to prepare a 170 decitex, 40 filament long-fiber yarn of electrically conductive nylon 6, which was then processed into an electrically conductive floc with a fiber diameter of 15 μm, the same procedure as in Example 2 was carried out to produce polyamide long fibers, an electrically conductive floc, and a brush. Results are shown in Table 1.

### Example 4

Except that the melt was discharged through a round orifice with a pore size of 0.4 mm to prepare a 170 decitex, 8 filament long-fiber yarn of electrically conductive nylon 6 which was then processed into an electrically conductive floc with a fiber diameter of 80 μm, the same procedure as in Example 2 was carried out to produce polyamide long fibers, an electrically conductive floc, and a brush. Results are shown in Table 1.

### Example 5

Except that a long fiber of electrically conductive nylon 6 as prepared in Example 2 was cut with a guillotine cutter into 0.5 mm short fibers, the same procedure as in

Example 2 was carried out to produce an electrically conductive floc and a brush. Results are shown in Table 1.

### Example 6

Except that a long fiber of electrically conductive nylon 6 as prepared in Example 2 was cut with a guillotine cutter into 3 mm short fibers, the same procedure as in Example 2 was carried out to produce an electrically conductive floc and a brush. Results are shown in Table 1.

### Example 7

A viscose to be used as a spinning solution was prepared from 8 mass % cellulose and 6 mass % aqueous sodium hydroxide solution, and electrically conductive carbon was added so that the carbon black particles added accounted for 15 mass % relative to the cellulose, followed by high speed stirring for mixing, and vacuum deaeration. The resulting viscose was spun at a discharge rate of 11 cc/min from the spinning nozzle of a Nelson type continuous spinning machine into a spinning bath of 51° C. consisting of 130 gaiter of H2SO4, 16 g/liter of ZnSO4, and 250 g/liter of NaSO4, and stretched by 16% while traveling over a 200 mm path through the bath, followed by hot-water treatment at 80° C. and roller drying at 100° C. to produce 170 decitex, 20 filament electrically conductive rayon long fiber at a rate of 100 m/min. For the resulting electrically conductive rayon long fiber, the same procedure as in Example 1 was carried out to produce an electrically conductive floc and a brush. Results are shown in Table 1.

### Example 8

A dimethyl sulfoxide (DMSO) solution of 94.2, 5.5, and 0.3 mol % of acrylonitrile (AN), methyl acrylate, and sodium methallyl sulfonate, respectively, was subjected to a polymerization process to prepare an acrylonitrile-based polymer A1. Then, adjustment was performed so that a polyether-ester block copolymer consisting of 25 mass % of polyethylene adipate and 75 mass % of polyethylene glycol and AN accounted for 70 wt % and 30 wt %, respectively, and graft polymerization was carried out in a DMSO solution to provide B2. Then, furnace black (#40, supplied by Mitsubishi Kasei Corporation) was added to B2 up to 35 mass % and mixed, and then mixed with Al so that the furnace black in the fiber accounted for 7.2 mass % in B2, followed by wet spinning to provide an electrically conductive acrylic long fiber. For the resulting electrically conductive acrylic long fiber, the same procedure as in Example 1 was carried out to produce an electrically conductive floc and a brush. Results are shown in Table 1.

### Example 9

Electrically conductive furnace black with an average particle diameter of 0.035 μm was add to polyester up to 20 mass %, kneaded, and processed into electrically conductive polyester pellets. The resulting pellets were melted at a melting temperature of 290° C., and discharged through a round orifice with a pore size of 0.3 mm, followed by cooling. A spinning lubricant diluted with water was supplied for deposition on the yarn so that it accounted for 0.7 mass %, and the unstretched yarn was wound up at a take-up speed of 800 m/min. Subsequently, it was stretched in a stretching machine at a supply roller speed of 300 m/min, supply roller temperature of 80° C., stretching roller speed of 500 m/min, and stretching roller temperature of 150° C., and twisted by a down twister at a rate of 15 t/m to produce a 170 decitex, 20 filament long-fiber yarn of electrically conductive polyester. The resulting long-fiber yarn of polyester had a specific resistance of 10⁶ Ωcm. For the resulting electrically conductive polyester long fiber, the same procedure as in Example 1 was carried out to produce an electrically conductive floc and a brush. Results are shown in Table 1.

### Example 10

A solution was prepared by dissolving 17 mass % polyvinyl alcohol with 0.15 mol % residual acetic acid group in hot water and also dissolving boric acid so that it accounted for 1.3 mass % relative to the polyvinyl alcohol. A line mixer was installed on the feed pile for supplying the solution to the nozzle, and an aqueous dispersion containing 15.1 mass % electrically conductive carbon black was injected and mixed with the solution to provide a final spinning liquid. Then, it was spun through a nozzle into a coagulating bath, followed by the steps for neutralization, moist heat treatment, rinsing, drying, heat stretching, and winding up to produce a 170 decitex electrically conductive vinylon long fiber consisting of 20 electrically conductive vinylon filaments. For the resulting electrically conductive vinylon long fiber, the same procedure as in Example 1 was carried out to produce an electrically conductive floc and a brush. Results are shown in Table 1.

### Example 11

Pellets of a nylon 6 material free of electrically conductive carbon black was spun and stretched as in Example 1 to prepare a 170 decitex, 20 filament nylon long fiber. The resulting nylon long fiber was cut into short fibers as in Example 1, and immersed in an aqueous solution containing 50 g/liter of pyrrole monomers, followed by stirring with ammonium persulfate as catalyst. Then, drying was performed at 120° C. for 5 minutes, and sieving was carried out using a 40-mesh metal gauze, followed by preparation of a brush as in Example 1. Results are shown in Table 1.

### Example 12

Except that the yarn of electrically conductive nylon 6 was wound 30,000 times a on a hank winder with a circumference of 3 m to prepare a tow of about 5,100,000 decitex, the same procedure as in Example 1 was carried out to produce polyamide long fibers, an electrically conductive floc, and a brush. Results are shown in Table 1.

### Comparative example 1

Except that the melt was discharged through a round orifice with a pore size of 0.15 mm to prepare a 170 decitex, 120 filament long-fiber yarn of electrically conductive nylon 6 which was then processed into an electrically conductive floc with a fiber diameter of 5 μm, the same procedure as in Example 1 was carried out to produce polyamide long fibers, an electrically conductive floc, and a brush. Results are shown in Table 2.

### Comparative example 2

Except that the melt was discharged through a round orifice with a pore size of 0.5 mm to prepare a 170 decitex, 4 filament long-fiber yarn of electrically conductive nylon 6 which was then processed into an electrically conductive floc with a fiber diameter of 150 μm, the same procedure as in Example 1 was carried out to produce polyamide long fibers, an electrically conductive floc, and a brush. Results are shown in Table 2.

### Comparative example 3

Except that a long fiber of electrically conductive nylon 6 as prepared in Example 1 was cut with a guillotine cutter into 0.1 mm short fibers, the same procedure as in Example 1 was carried out to produce an electrically conductive floc and a brush. Results are shown in Table 2.

### Comparative example 4

Except that a long fiber of electrically conductive nylon 6 as prepared in Example 1 was cut with a guillotine cutter into 8 mm short fibers, the same procedure as in Example 1 was carried out to produce an electrically conductive floc and a brush. Results are shown in Table 2.

### Comparative example 5

Except that a tow prepared from a long fiber of electrically conductive nylon 6 as in Example 1 was cut with a guillotine cutter without wrapping it in paper, the same procedure as in Example 1 was carried out to produce an electrically conductive floc and a brush. Results are shown in Table 2.

As seen from Tables 1 and 2, the electrically conductive brushes produced from the electrically conductive floc samples with a fiber diameter of 10 to 100 μm prepared in Examples 1 to 8 were not bent down significantly and had a high flocking density, resulting in high initial image quality and high printing durability. The electrically conductive brushes produced from the electrically conductive floc samples with a fiber length of 0.1 to 5 mm prepared in Examples 1 to 8 were free of toner filming as well as hardening of the brush surface due to entry of toner, resulting in high printing durability. The electrically conductive brushes produced from the electrically conductive floc samples with a fiber length variation of 5% or less prepared in Examples 1 to 8 had an even brush surface, resulting in high initial image quality. As compared with these, the brush bristles produced form the electrically conductive floc sample with a fiber diameter of 5 μm (Comparative example 1) were easily bent and unable to apply a sufficient contact pressure to the photoconductor or toner, and consequently, failed to electrically charge the photoconductor or toner enough to form an image. The electrically conductive brush produced from the electrically conductive floc sample with a fiber diameter of 150 μm (Comparative example 2) had a low flocking density and accordingly a low charge density, resulting in low initial quality.

The electrically conductive brush produced from the electrically conductive floc sample with a fiber length of 0.05 mm (Comparative example 3) suffered hardening of the brush surface due to the entry of toner into the brush surface, and in addition, toner filming was caused as a result of fusion of the toner, resulting in an increase in the resistance of the brush surface and a decrease in the printing durability. In the case of the electrically conductive floc sample with a fiber length of 8 mm (Comparative example 4), floc entanglement took place during the electrostatic flocking process, and individual fibers did not disperse adequately, preventing the surface to be flocked. The brush produced from the electrically conductive floc sample with a fiber length variation of 6.1% (Comparative example 5) had a rough brush surface and failed to achieve uniform electrical charging of the photoconductor or toner, resulting in low initial image quality.

TABLE 1

| | | Example 1 | Example 2 | Example 3 | Example 4 | Example 5 | Example 6 |
|---|---|---|---|---|---|---|---|
| Material | | nylon 6 | nylon 6 | nylon 6 | nylon 6 | nylon 6 | nylon 6 |
| Fiber diameter | μm | 30 | 30 | 15 | 80 | 30 | 30 |
| Fiber length | mm | 1.5 | 1.5 | 1.5 | 1.5 | 0.5 | 3 |
| Fiber length variation | % | 2.5 | 1.5 | 1.6 | 1.4 | 1.2 | 2 |
| Method to give electrical | | Adding | Adding | Adding | Adding | Adding | Adding |
| conductivity | | electrically | electrically | electrically | electrically | electrically | electrically |
| | | conductive carbon | conductive carbon | conductive carbon | conductive carbon | conductive carbon | conductive carbon |
| Content of electrically | % | 25 | 25 | 25 | 25 | 25 | 25 |
| conductive fine particles | | | | | | | |
| Specific resistance | Ωcm | 10⁶ | 10⁶ | 10⁶ | 10⁶ | 10⁶ | 10⁶ |
| Jumping capability | seconds | 15 | 15 | 15 | 15 | 15 | 15 |
| | rating | ⊚ | ⊚ | ⊚ | ⊚ | ⊚ | ⊚ |
| Initial image quality | | ⊚ | ⊚ | ⊚ | ⊚ | ⊚ | ⊚ |
| Printing durability | | ⊚ | ⊚ | ⊚ | ⊚ | ⊚ | ⊚ |
| | | Example 7 | Example 8 | Example 9 | Example 10 | Example 11 | Example 12 |
| Material | | rayon | acrylic | polyester | vinylon | nylon 6 | nylon 6 |
| Fiber diameter | μm | 35 | 31 | 34 | 40 | 30 | 30 |
| Fiber length | mm | 1.5 | 1.5 | 1.5 | 1.5 | 1.5 | 1.5 |
| Fiber length variation | % | 2.8 | 2.7 | 2.6 | 2.7 | 2.5 | 3.8 |
| Method to give electrical | | Adding | Adding | Adding | Adding | Coating with | Adding |
| conductivity | | electrically | electrically | electrically | electrically | polypyrrole | electrically |
| | | conductive carbon | conductive carbon | conductive carbon | conductive carbon | | conductive carbon |
| Content of electrically | % | 15 | 7.2 | 20 | 15.1 | — | 25 |
| conductive fine particles | | | | | | | |
| Specific resistance | Ωcm | 10⁶ | 10⁴ | 10⁴ | 10¹² | 10⁴ | 10⁶ |
| Jumping capability | seconds | 20 | 18 | 17 | 16 | 18 | 16 |
| | rating | ⊚ | ⊚ | ⊚ | ⊚ | ⊚ | ⊚ |
| Initial image quality | | ⊚ | ⊚ | ⊚ | ⊚ | ⊚ | ○ |
| Printing durability | | ⊚ | ⊚ | ⊚ | ⊚ | ○ | ○ |

The invention relates to an electrically conductive floc to be used in electrophotographic machines such as xerographic copier, facsimile, and printer. Specifically, it relates to an electrically conductive floc to be used in electrically conductive brushes manufactured by electrostatic flocking.

1. An electrically conductive floc comprising electrically conductive chemical fibers wherein said chemical fibers have a diameter of 10 to 100 μm, a fiber length of 0.5 to 5 mm, and a fiber length variation of 5% or less.

2. An electrically conductive floc as specified in claim 1 wherein said chemical fibers contain electrically conductive fine particles.

3. An electrically conductive floc as specified in claim 2 wherein said electrically conductive fine particles are of carbon black and account for 5 to 40 mass % of the chemical fibers.

4. An electrically conductive floc as specified in claim 1 wherein said chemical fibers are of thermoplastic resin.

5. An electrically conductive floc as specified in claim 4 wherein said thermoplastic resin is polyamide.

6. An electrically conductive brush produced by electrostatic flocking with an electrically conductive floc as specified in claim 1.

7. A production method for an electrically conductive floc as specified in claim 1 wherein a tow of electrically conductive chemical fibers with a fineness of 500,000 to 5,000,000 decitex is fixed to prevent its movement in the perpendicular direction to the fiber axis, followed by cutting the tow to produce short fibers and subjecting them to electrostatic treatment.
